(19) United States
(12) Patent Application Publication
(10) Pub. No.: US 2019/0351344 A1
(43) Pub. Date: Nov. 21, 2019

(54) PARTY INFLATABLE SUIT AND INFLATION DEVICE THEREOF

(71) Applicant: Yumin Gu, Jinhua (CN)

(72) Inventor: Yumin Gu, Jinhua (CN)

(21) Appl. No.: 16/416,288

(22) Filed: May 20, 2019

(30) Foreign Application Priority Data
May 21, 2018 (CN) 201820756703 .0

(51) Int. Cl. A63H 27/10; G06F 13/42

(52) U.S. Cl. CPC A63H 27/10; A41D 1/00; G06F 13/4282

(57) ABSTRACT

The utility model discloses an inflation device of a party inflatable suit, comprising a blower and a battery box connected therewith, and a mounting cover for fixing the blower at an inflation port of the inflatable suit, wherein mutually engaged gears are arranged on the inner periphery of the mounting cover and the outer periphery of a hollow cylindrical portion at the top of an upper shell of the blower, and the blower is fixed at the inflation port of the inflatable suit by gear engagement. The party inflatable suit is inflated by the inflation device connected at the inflation port thereof, and is firm in connection and convenient in use.

### TECHNICAL FIELD

The utility model relates to the technical field of apparel design, and particularly relates to a party inflatable suit and an inflation device thereof.

### BACKGROUND

With the development of society and the continuous improvement of the living standard of people, people often go to various parties, so that sometimes they need a variety of party suits at the parties. To enable the effect of a party be better and attract attention, party inflatable suits are invented, a variety of party inflatable suits are emerged, and the inflatable suits are inflated by inflation devices. A variety of shapes bring endless happiness to people.

Thus, the problem to be urgently solved by those skilled in the art is how to provide a party inflatable suit which is firm in connection and convenient in use and an inflation device thereof.

### SUMMARY

In view of this, the utility model provides a party inflatable suit which is firm in connection and convenient in use and an inflation device thereof.

To achieve the above purpose, the utility model provides the following technical solution:

an inflation device of a party inflatable suit, comprising: a blower and a battery box connected therewith, and further comprising a mounting cover for fixing the blower at an inflation port of the inflatable suit, wherein mutually engaged gears are arranged on the inner periphery of the mounting cover and the outer periphery of a hollow cylindrical portion at the top of an upper shell of the blower, the blower is fixed at the inflation port of the inflatable suit by gear engagement, the side surface of the battery box is provided with a USB interface, a plug of a USB cable is connected to the USB interface, and a connecting line of the USB cable is connected with the blower through a wiring hole in a lower shell of the blower.

Preferably, in the inflation device of a party inflatable suit, the device further comprises a Bluetooth and a lighting device.

Preferably, in the inflation device of a party inflatable suit, the lighting device is controlled by a configured remote controller.

Preferably, in the inflation device of a party inflatable suit, the wiring hole is a circular hole, and the connecting line of the USB cable is a round-head line.

Preferably, in the inflation device of a party inflatable suit, the party inflatable suit is inflated by the inflation device connected at the inflation port thereof.

It can be known from the above technical solution that compared with the prior art, the utility model discloses a party inflatable suit and an inflation device thereof. The mounting cover of the inflation device is connected with the blower of the inflation device by gear engagement, and the battery box of the inflation device is connected with the blower by the USB cable for convenient connection or disconnection. While in use, the blower is inserted in the inflatable suit through the inflation port of the inflatable suit, the hollow cylindrical portion at the top of the upper shell of the blower stretches out of the inflatable suit, the mounting cover of the inflation device is rotated, and the blower is fixed at the inflation port of the inflatable suit by gear engagement, thereby being firm in connection and convenient in use.

### DESCRIPTION OF DRAWINGS

To more clearly describe the technical solutions in the embodiments of the utility model or in the prior art, the drawings required to be used in the description of the embodiments or the prior art will be simply presented below. Apparently, the drawings in the following description are merely embodiments of the utility model, and for those ordinary skilled in the art, other drawings can also be obtained according to the drawings without contributing creative labor.

FIG. 1 is a structural schematic diagram showing a connection between a party inflatable suit and an inflation device of the utility model.

FIG. 2 is a structural schematic diagram of a party inflatable suit of the utility model.

Legends: 1. party inflatable suit; 2. party inflation device; 21. blower; 22. mounting cover; 23. USB cable; 24. battery box; 221. gear.

### DETAILED DESCRIPTION

The technical solutions in the embodiments of the utility model will be clearly and fully described below in combination with the drawings in the embodiments of the utility model. Apparently, the described embodiments are merely part of the embodiments of the utility model, not all of the embodiments. Based on the embodiments in the utility model, all other embodiments obtained by those ordinary skilled in the art without contributing creative labor will belong to the protection scope of the utility model.

Embodiments of the utility model disclose a party inflatable suit which is firm in connection and convenient in use and an inflation device thereof.

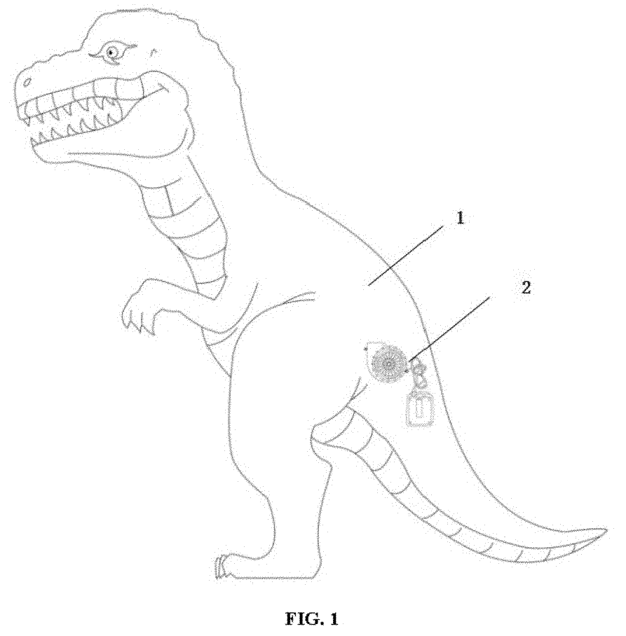

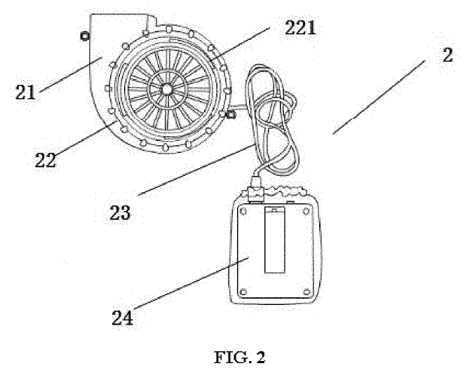

Refer to FIG. 1 and FIG. 2, which show the party inflatable suit and the inflation device disclosed by the utility model.

An inflation device 2 of a party inflatable suit, comprising: a blower 21 and a battery box 24 connected therewith, and further comprising a mounting cover 22 for fixing the blower 21 at an inflation port of the inflatable suit, wherein mutually engaged gears 221 are arranged on the inner periphery of the mounting cover 22 and the outer periphery of a hollow cylindrical portion at the top of an upper shell of the blower 21, the blower 21 is fixed at the inflation port of the inflatable suit by gear engagement, the side surface of the battery box 24 is provided with a USB interface, a plug of a USB cable 23 is connected to the USB interface, and a connecting line of the USB cable 23 is connected with the blower 21 through a wiring hole in a lower shell of the blower 21.

A party inflatable suit 1, wherein the party inflatable suit 1 is inflated by the inflation device 2 connected at the inflation port thereof.

The mounting cover of the inflation device of the utility model is connected with the blower of the inflation device of the inflation device by gear engagement, and the battery box of the inflation device is connected with the blower by the USB cable for convenient connection or disconnection. While in use, the blower is inserted in the inflatable suit through the inflation port of the inflatable suit, the hollow cylindrical portion at the top of the upper shell of the blower stretches out of the inflatable suit, the mounting cover of the inflation device is, rotated, and the blower is fixed at the inflation port of the inflatable suit by gear engagement, thereby being firm in connection and convenient in use.

To further optimize the above technical solution, the device further comprises a Bluetooth and a lighting device.

To further optimize the above technical solution, the lighting device is controlled by a configured remote controller.

To further optimize the above technical solution, the wiring hole is a circular hole, and the connecting line of the USB cable 23 is a round-head line.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the utility model. Many modifications to these embodiments will be apparent to those skilled in the art. The general principle defined herein can be realized in other embodiments without departing from the spirit or scope of the utility model. Therefore, the utility model will not be limited to these embodiments shown herein, but will conform to the widest scope consistent with the principle and novel features disclosed herein.

What is claimed is:

1. An inflation device of a party inflatable suit, comprising: a blower and a battery box connected therewith, and further comprising a mounting cover for fixing the blower at an inflation port of the inflatable suit, wherein mutually engaged gears are arranged on the inner periphery of the mounting cover and the outer periphery of a hollow cylindrical portion at the top of an upper shell of the blower, the blower is fixed at the inflation port of the inflatable suit by gear engagement, the side surface of the battery box is provided with a USB interface, a plug of a USB cable is connected to the USB interface, and a connecting line of the USB cable is connected with the blower through a wiring hole in a lower shell of the blower.

2. The inflation device of a party inflatable suit according to claim 1, wherein the device further comprises a Bluetooth and a lighting device.

3. The inflation device of a party inflatable suit according to claim 2, wherein the lighting device is controlled by a configured remote controller.

4. The inflation device of a party inflatable suit according to claim 1, wherein the wiring hole is a circular hole, and the connecting line of the USB cable is a round-head line.

5. The inflation device of a party inflatable suit according to claim 1, wherein the party inflatable suit is inflated by the inflation device connected at the inflation port thereof.
